(19) United States
(12) Patent Application Publication
(10) Pub. No.: US 2026/0079384 A1
(43) Pub. Date: Mar. 19, 2026

(54) Configurable Magnetic Mount System with Flexible Arms and Interchangeable Polygonal Pucks

(71) Applicant: Thomas Hirschmann, Evergreen, CO (US)

(72) Inventor: Thomas Hirschmann, Evergreen, CO (US)

(21) Appl. No.: 19/079,666

(22) Filed: Mar. 14, 2025

Related U.S. Application Data
(63) Continuation-in-part of application No. 18/887,224, filed on Sep. 17, 2024, now Pat. No. 12,276,378.

(51) Int. Cl. G03B 17/56; F16M 13/04

(52) U.S. Cl. CPC G03B 17/561; F16M 13/04

(57) ABSTRACT

A mounting system with flexible arms radiating from a central intersection point, each arm having specified length and diameter dimensions and embedded magnets providing defined holding force. The arms are constructed from materials enabling 180-degree bending while maintaining structural integrity. The system includes an interchangeable polygonal puck having between 3-20 sides, with regular or irregular configurations. The puck incorporates retention grooves, variable facet angles, and locking mechanisms including snap-fit, ball-detent, and bayonet-style options. The flexible arms enable conformity to irregular surfaces while maintaining magnetic alignment when opposing bodies are placed on either side of an object.

### CROSS-REFERENCE TO RELATED APPLICATIONS

This application is a continuation-in-part of U.S. patent application Ser. No. 18/887,224, titled “Flexible Magnetic Mounting System for Devices,” filed on Sep. 17, 2024, which is hereby incorporated by reference in its entirety with benefit claimed thereto.

### FIELD OF THE INVENTION

The present invention relates to mounting systems, particularly to a flexible, magnetic mounting system designed for securing action cameras and other devices to various surfaces and objects in multiple environments.

### DESCRIPTION OF THE RELATED ART

Action cameras, such as those produced by GoPro, are popular for capturing dynamic, first-person perspectives in sports and other activities. However, existing mounting solutions for these cameras often present several challenges.

Traditional camera mounts, particularly those designed for chest placement, pose significant safety risks during physical activities. These mounts often involve rigid structures that can lead to discomfort or injury upon impact, such as during falls or collisions. The rigid nature of these mounts can interfere with protective gear or even become a point of impact that exacerbates injury rather than preventing it. This issue is particularly critical in high-impact sports or activities where the risk of sudden impacts is high. Consequently, the safety concerns associated with these mounts have led to restrictions or outright bans by various sports authorities, who cite the potential for increased harm to the wearer.

The safety issues associated with traditional mounts have not only affected user safety but also compliance with sports regulations. Many organized sports and recreational activities have strict guidelines regarding equipment and accessories that participants can use during events. Traditional mounts often fail to meet these safety standards, leading to their prohibition in certain sports. This regulatory environment necessitates a mounting solution that can be safely used without violating rules or exposing participants to unnecessary risks.

The limitations of traditional mounts highlight the need for an innovative solution that prioritizes safety without compromising functionality. A mount that offers flexibility and reduces rigid components can significantly decrease the risk of injury. By integrating materials and designs that absorb impact and conform more naturally to the body or the mounting surface, such a solution would address the critical safety concerns that currently limit the use of action camera mounts in various physical activities. This approach would not only enhance wearer safety but also potentially expand the approval of camera mounts in regulated environments, offering users greater freedom and security in capturing their experiences.

The prevalent use of manual screwing mechanisms in current camera mounts presents significant convenience issues for users. This traditional method requires users to manually tighten screws to secure the camera, a process that is not only time-consuming but also cumbersome, especially in environments where dexterity is compromised, such as in cold weather or when wearing gloves. The need to remove gloves or pause activities to adjust or relocate the camera interrupts the user experience and can lead to missed moments or decreased productivity, particularly in dynamic settings like sports or active filming scenarios.

The interruptions required to adjust traditional mounts can significantly detract from the overall user experience. For enthusiasts and professionals alike, the ability to quickly and effortlessly adjust camera angles or positions is crucial. The manual screwing mechanisms not only slow down this process but also introduce a level of frustration and inefficiency, which can affect the quality and quantity of the captured content. This is particularly problematic in environments where timing and speed are critical, such as in documentary filmmaking or fast-paced sports.

These inconveniences underscore the need for a more user-friendly mounting solution that eliminates the need for manual screwing and allows for quick, tool-free adjustments. A mount incorporating magnetic attachments, for example, could offer a significant improvement by enabling users to easily attach or adjust their cameras with minimal effort and without the need to halt their activities. Such a solution would not only enhance the convenience and usability of camera mounts but also broaden their appeal to a wider range of users, from amateur adventurers to professional cinematographers, who require quick and reliable adjustments in diverse operating conditions.

Traditional camera mounts are typically engineered for attachment to flat, stable surfaces, which significantly limits their versatility. This design constraint means that they cannot securely attach to non-planar or irregular surfaces, which are commonly encountered in various real-world environments such as outdoor landscapes or in automotive contexts. For instance, adventurers looking to capture video while hiking, climbing, or participating in off-road activities often find that conventional mounts fail to adhere securely to natural surfaces like rocks, tree limbs, or vehicle exteriors. This limitation not only restricts the usability of the mounts but also affects the quality and feasibility of capturing dynamic, immersive content in diverse settings.

The inability of traditional mounts to adapt to varied surfaces severely restricts their practical applications. In professional settings, such as in the automotive industry or in field research, the need to attach cameras or other equipment securely on non-flat surfaces is common. The lack of flexibility in existing mount designs can hinder the effectiveness of these tools, leading to compromised safety, reduced efficiency, and limited angles for documentation or monitoring. This is particularly problematic in industries where detailed visual access in complex environments is crucial, such as during machinery inspections or in wildlife documentation.

The limitations highlighted by traditional mounting systems underscore the necessity for a more adaptable solution that can conform to a variety of shapes and surfaces. A mount that incorporates flexible arms and adjustable components could provide a much-needed enhancement in this area, offering secure attachment not only to flat surfaces but also to those that are curved, angular, or textured. Such versatility would greatly expand the utility of mounts across different sectors and activities, enabling users to deploy their cameras and other devices in previously challenging or inaccessible locations, thereby broadening the scope and capabilities of their equipment.

The materials commonly used in existing camera mounts often fail to withstand the rigors of extreme environmental conditions. Many mounts are made from plastics or metals that are not suited to extreme temperatures, which can lead to their deformation, brittleness, or failure. This is particularly problematic for users who engage in activities in harsh climates, such as mountaineering in cold environments or desert photography, where temperatures can drastically affect the integrity of mount materials. Additionally, prolonged exposure to elements such as UV rays, moisture, and salt can accelerate the wear and tear on these materials, further reducing their lifespan and reliability.

The degradation of materials not only shortens the lifespan of the mounts but also impacts their performance and safety. As the materials weaken, the risk of a mount failing during use increases, which can lead to equipment damage or loss, and in some cases, safety hazards for the user. For professionals and enthusiasts alike, the reliability of mount materials is crucial for ensuring that equipment remains secure and functional throughout its intended use, regardless of environmental conditions. The failure of a mount due to material degradation can result in significant financial losses and missed opportunities to capture crucial moments.

These material limitations highlight the need for mounts constructed from more durable, resilient materials that can withstand a wide range of environmental conditions without degrading. Materials such as commercial urethane, which is known for its durability, temperature resistance, and UV stability, offer a promising alternative. By utilizing such materials, the next generation of mounts could significantly extend the operational life and reliability of these devices, ensuring that they remain functional and secure in a variety of challenging conditions. This would not only enhance user confidence in the equipment but also expand the potential applications of mounts in more extreme and varied environments.

Moreover, traditional mounting systems face significant limitations in their ability to securely attach to varied surface geometries and shapes. Existing mounts with rigid structures and fixed configurations often fail to provide adequate contact and grip across different mounting scenarios, leading to potential instability and device detachment. The inability to conform to irregular surfaces severely restricts their practical applications, particularly in professional settings where secure attachment to non-flat surfaces is crucial.

Current mounting solutions further lack the adaptability needed for dynamic environments where quick adjustments and repositioning are essential. The prevalent use of manual screwing mechanisms and fixed mounting points creates significant convenience issues, requiring users to halt activities for adjustments and potentially miss critical moments or decrease productivity. These limitations are particularly problematic in fast-paced environments where timing and efficiency are crucial.

Existing mounting systems suffer from rotational instability and insufficient grip, particularly when subjected to vibration or impact forces. Traditional circular designs provide limited points of contact and can gradually loosen during use, creating safety concerns and potential equipment damage. The lack of positive locking features in current designs leads to unreliable attachment that can compromise both equipment security and user safety.

The materials commonly used in traditional mounting systems often fail to provide the necessary flexibility for conforming to varied surfaces while maintaining sufficient strength for secure attachment. This material limitation results in mounts that either lack the rigidity needed for stable mounting or the flexibility required for adaptation to different mounting scenarios. Additionally, current materials often degrade when exposed to environmental conditions, leading to reduced performance and potential failure.

Conventional mounting systems typically offer limited configurability, restricting users to fixed arrangements that may not suit their specific needs. The inability to adjust the number and arrangement of attachment points prevents optimization for different weight distributions and stability requirements. This inflexibility particularly impacts applications where varying levels of support and security are needed across different use scenarios.

For the above and other reasons, it remains desirable to provide an improvement over traditional mounting systems.

### SUMMARY OF THE INVENTION

The preferred embodiment of the invention presents a novel mounting system designed to address the limitations of traditional camera mounts by enhancing safety, convenience, versatility, and durability associated with mounting items that otherwise might not be considered wearable.

The preferred embodiment of the invention comprises flexible arms equipped with strong magnetic components that facilitate easy and secure attachment to a variety of surfaces, especially including clothing. These magnets, capable of holding significant weight, allow for rapid adjustments without the need for tools. In the preferred embodiment, the flexible arms are made from durable material such as commercial urethane, ensuring durability and stability across extreme temperatures and environmental conditions.

This innovative design of the preferred embodiment not only makes the mounting system safer and more user-friendly but also extends its applicability beyond traditional uses, accommodating a wide range of activities and industries. The preferred embodiment of the invention is poised to fundamentally alter the way cameras and other devices are mounted, offering a safer, more convenient, versatile and fundamentally different alternative to existing mounting solutions.

### BRIEF DESCRIPTION OF THE FIGURES

FIG. 1 depicts an embodiment of the invention comprising an attached action camera.

FIG. 2 depicts an embodiment of the invention comprising an expansion disc.

FIGS. 3A and 3B depict placement of magnetic discs on the interior of a garment in accordance with an exemplary intended use.

FIGS. 4A and 4B depict placement of the main body in alignment with the placement of magnetic discs on the interior of a garment as depicted in FIGS. 3A and 3B in accordance with an exemplary intended use.

FIG. 5 depicts a placement of the system comprising an action camera in an embodiment attached to outerwear in accordance with an exemplary use associated with skiing.

FIG. 6A depicts cross-sectional view of an exemplary embodiment comprising individual magnets placed on the interior of a garment with the main body placed in alignment on the opposite side of a garment while retaining an action camera in accordance with an intended use.

FIG. 6B depicts cross-sectional view of an exemplary embodiment comprising a unified body comprising magnets placed on the interior of a garment with the main body placed in alignment on the opposite side of a garment while retaining an action camera in accordance with an intended use.

FIG. 7 depicts various puck configurations in accordance with embodiments of the invention.

FIG. 8 depicts a cross sectional view of the interlocking profile of the retention groove in an exemplary embodiment.

### DETAILED DESCRIPTION

The preferred embodiment of the invention pertains to a novel mounting system designed to securely attach cameras and other devices to various surfaces and objects. This system addresses the limitations of traditional mounts by offering enhanced safety, increased convenience, greater versatility, and improved durability. The design incorporates a main body 100 comprising flexible arms 110 with integrated magnetic components and is constructed from high-quality, resilient materials.

Each of the flexible arms 110 of the main body 100 in the preferred embodiment is constructed from a high-grade commercial urethane, known for its exceptional flexibility and durability. This material choice allows the arms to be both sturdy and pliable, capable of bending and wrapping around objects without losing structural integrity or breaking. Strategically placed within each arm in the preferred embodiment are neodymium magnets. These magnets are chosen for their strong magnetic force relative to their size, allowing for secure attachment to any metallic surface, a body substantially mirroring the main body that comprises embedded magnets, 120, or to opposing individual magnets 125 in association with intended use cases.

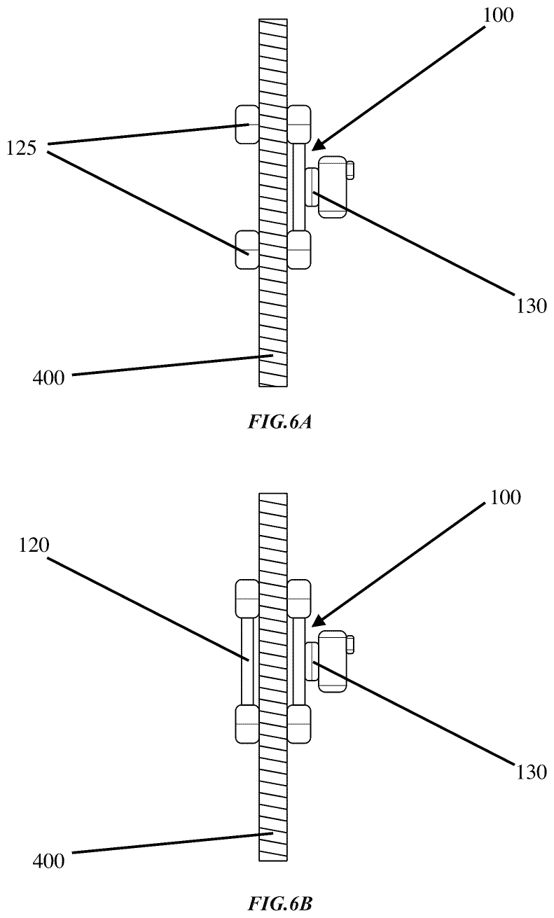

The flexible arms 110 are designed with a specific length and diameter to optimize flexibility and magnetic strength. The length allows sufficient reach to encircle larger objects in accordance with some intended use cases, while the diameter is slim enough to ensure easy manipulation but robust enough to prevent sagging or bending under the weight of attached devices. In a preferred usage, the arms of the main body 100 are placed corresponding to the arms of another body mirroring the main body 120 on another side of an object 400, such as fabric, to allow the opposing magnets to generate a clamping force upon the object 400 as depicted by FIG. 6B.

Each magnet within the flexible arms 110 in an embodiment is rated for a specific holding force, calculated to support the weight of common devices used with the mount, such as cameras, lights, or tools. The magnetic strength is balanced to provide a strong hold without being overly difficult to detach when adjustments are needed.

The multi-arm design in embodiments distributes the weight and tension substantially evenly in embodiments when placed upon clothing, reducing the risk of slippage or detachment. This design is particularly effective in maintaining stability and security, even in dynamic environments where movement or vibrations may be present. The inherent flexibility of the arms allows the mount to conform to a wide range of shapes.

The mounting system in its preferred embodiment features two mirrored bodies, including one main body 100 configured to retain an object and another substantially mirrored opposing body with corresponding embedded magnets 120 for placement on the other side of an object such as clothing in accordance with an intended use. In an embodiment, each body comprises three flexible arms 110, which form the core structural component. This tri-arm configuration provides a stable and versatile base that can adapt to various attachment needs. The three arms are strategically designed to maximize stability and flexibility. In alternative embodiments, each of the mirrored bodies comprises an amount of flexible arms 110 of plural number other than three.

The three flexible arms 110 of the main body 100 in an embodiment comprise two top arms and a bottom arm. The two top arms are primarily responsible for gripping and securing to a more superior portion of an object, such as clothing, or surface. Their positioning allows for an adaptable grip that can conform to the contours of the object being mounted by substantially aligning with the two top arms of a corresponding mirrored body placed on the other side of the object. In an embodiment, the bottom arm acts as a stabilizing force, anchoring the mount by attaching via clamping magnetic force to a corresponding bottom arm of a mirrored body placed on the opposite side of an object, and providing additional support. In association with an exemplary use, the bottom arm is particularly useful in balancing the mount on uneven or sloped surfaces.

In embodiments, the flexible arms 110 of a main body 100 are in essence equally responsible to gripping and securing to an object via clamping magnetic force following alignment of magnets to flexible arms 110 of a second mirrored body placed on the opposite side of an object, such as clothing.

Each of the flexible arms 110 of the main body 100 in the preferred embodiment is constructed from a high-grade commercial urethane, known for its exceptional flexibility and durability. This material choice ensures that the flexible arms 110 can be bent or twisted to a significant degree without risking damage or loss of functionality. In accordance with the preferred embodiment, the main body 100 further comprises a mount of one of a variety of configurations. The inherent flexibility of the material of the flexible arms 110 in accordance with an intended use allows the flexible arms 110 to wrap around a variety of objects, from cylindrical poles to angular structures, making the mount suitable for diverse environments.

In the preferred embodiment, the system incorporates magnetic components that are integral to its functionality and versatility. Each of the flexible arms 110 of the main body 100 is embedded with high-quality magnets 115, which are designed to provide a substantial holding force to secure the mount in place across various applications. In the preferred embodiment, the magnets 115 are circular and disk shaped. In the preferred embodiment, the magnets 115 are located substantially distal from the intersection point 111 of each of the flexible arms 110 of a body.

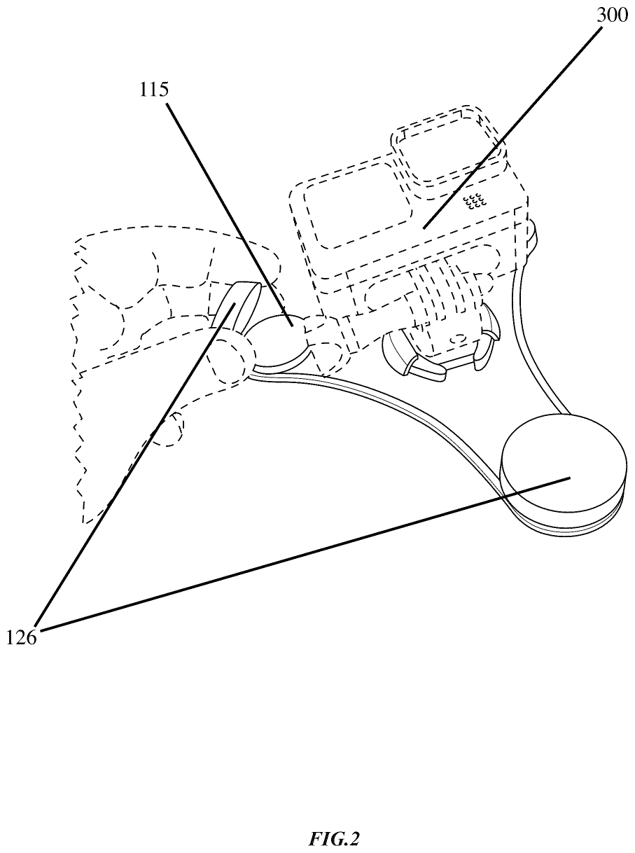

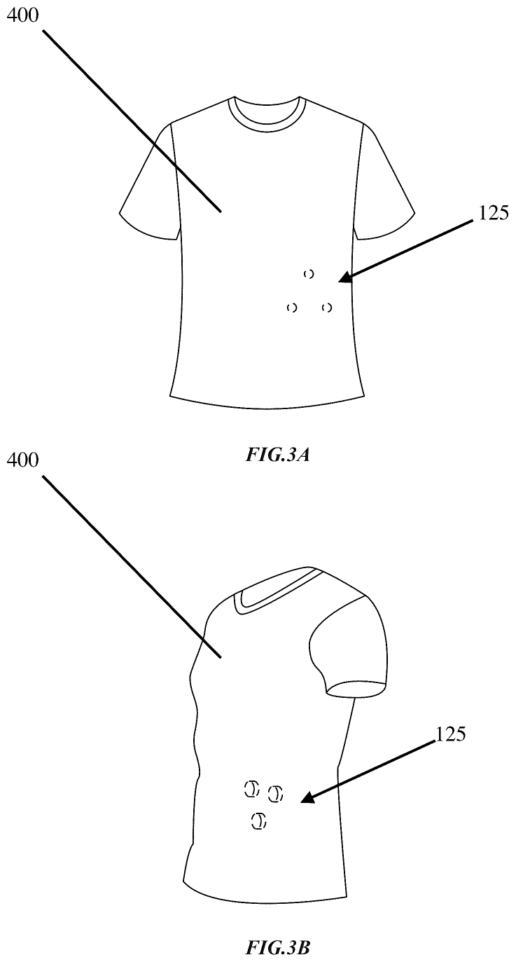

In an embodiment, within each flexible arm, magnets 115 are embedded. These magnets 115 are crucial for providing a secure attachment to metallic surfaces without the need for clamps or screws. Each magnet 115 embedded in the arms in an embodiment offers approximately 2.5 lbs of holding force, which can be enhanced by stacking additional bodies substantially mirroring the main body 100, or additional magnetic discs for force multiplication 126 upon each of the magnets 115 of the flexible arms 110, as depicted in an example by FIG. 2, for a combined force of up to 5 lbs. This force is sufficient for stable attachment in most everyday applications, ensuring that devices or tools attached to the mount remain secure even under conditions of movement or vibration. When the magnets from multiple arms are used in conjunction, they collectively provide about 5 pounds of holding force, enhancing the stability and security of the mount. This feature is particularly beneficial for quick setups and adjustments, as it eliminates the need for tools and manual fastening.

For applications requiring even greater stability, the design of the magnetic components allows for the stacking of magnets, as depicted by FIG. 2. This stacking capability is a feature of the preferred embodiment that can increase the total magnetic holding force by up to 80%. This significant boost in holding power is essential for heavier or more demanding applications, such as securing equipment in industrial settings or in environments with high levels of activity and motion. The system's design facilitates a magnetic force multiplication effect achieved through the stacking of magnetic discs for force multiplication 126 upon or substantially near to one or more of the magnets embedded within the flexible arms 115, which significantly enhances its versatility and applicability across various settings. In scenarios where one body of the mount, equipped with magnets, is placed on the interior of a piece of clothing and a corresponding body with magnets is aligned on the exterior, the magnetic forces from both bodies interact to create a compounded magnetic effect. This interaction effectively doubles the magnetic holding force exerted through the clothing, ensuring that the main body 100 and the mount remain securely in place despite the barrier posed by the fabric. This stacking and interaction of magnetic fields not only stabilize the main body 100 against slippage but also allow the mount of the main body 100 to carry heavier devices 300 or tools without compromise. The increased magnetic force ensures that even in dynamic environments or when subjected to movements and vibrations, the main body 100 maintains a robust grip, making it ideal for applications ranging from securing cameras during active sports to holding heavy tools in industrial work settings. This magnetic force multiplication is a critical feature that adapts the mounting system for heavier and more demanding uses, providing reliability and security in a wide array of practical applications.

In accordance with various embodiments, the multiplication of magnetic effects through placement of multiple bodies directly in alignment with and upon one another, or the addition of individual magnetic discs 126. When multiple bodies of the mount, each embedded with magnets 115, are stacked upon each other with their magnets precisely aligned, the magnetic fields from each body synergize to create a significantly stronger cumulative magnetic force. This alignment and stacking amplify the overall magnetic attraction, enabling the system to support heavier loads and provide a more secure attachment. Alternatively, the system also supports the enhancement of magnetic force by placing individual magnetic discs 126 near the magnets embedded in each flexible arm 115. These additional discs 126 act as force multipliers, intensifying the local magnetic field where they are placed. This flexibility in configuring the magnetic strength is particularly advantageous in scenarios requiring variable holding forces, such as in environments with varying levels of mechanical vibration or when different weights or sizes of equipment need to be securely mounted. This capability to customize the magnetic strength dynamically enhances the system's utility across a diverse range of applications, ensuring both adaptability and robust performance.

The present inventor has recognized that the magnetic components provide ease of use and flexibility of the system in accordance with the preferred embodiment. The magnetic force retention mechanism allows for quick adjustments and secure attachments without the need for manual screwing, facilitating a tool-free setup. This feature is particularly beneficial in scenarios where time and efficiency are crucial, such as in fast-paced work environments or during activities where adjusting the position of the mounted device needs to be as effortless as possible.

The magnets are designed to be durable and resistant to environmental factors that could potentially weaken their hold, such as moisture, dust, and temperature fluctuations. This durability ensures that the magnetic properties are maintained over time, providing long-term reliability and performance.

The design of the mounting system in its preferred embodiment incorporates a dual-body configuration, featuring a first mirrored body, optionally a main body 100, and a second mirrored body, where each body is equipped with flexible arms 110 embedded with magnets. This configuration allows for a unique method of securing the main body 100 and mount to clothing, enhancing both stability and ease of use without damaging the fabric.

Each body of the mounting system, referred to as the first body or main body 100 and the second body or opposing body 120 in accordance with an embodiment, is designed to mirror the other in terms of shape, size, and magnetic alignment. The flexible arms 110 on each body are strategically embedded with magnets that align oppositely, ensuring that when placed opposite each other on either side of a piece of clothing 400, they attract magnetically.

In embodiments, the mounting system incorporates one or more interchangeable pucks 130 that serve as the primary contact points for attaching various devices. These pucks 130 are designed to offer versatility and security in device attachment. In an embodiment, each puck 130 is constructed from durable ABS polyurethane, chosen for its strength and resistance to environmental factors such as temperature fluctuations and UV exposure. The material ensures that the pucks 130 remain robust and functional even under extreme conditions. The pucks 130 in an embodiment are engineered to be as low-profile as possible while still maintaining a high degree of structural integrity. This design minimizes wind resistance and visual obtrusiveness, making them suitable for a wide range of applications, including automotive uses where they can withstand speeds of up to 90 mph without detaching.

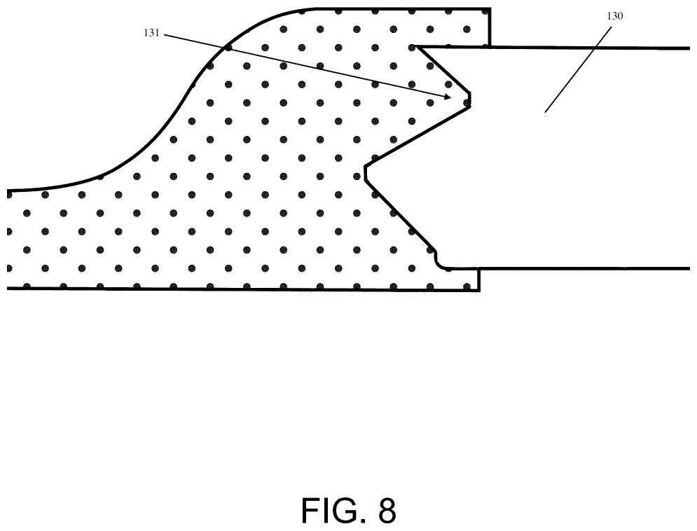

In an embodiment, each puck 130 comprises a retention groove 131 that encircles its perimeter. In an exemplary embodiment, the cross sectional profile of the retention groove 131 is depicted by FIG. 8. This groove 131 is designed to securely lock the puck 130 into place once attached to the mounting system, preventing slippage or rotation of the device during use. The groove 131 also facilitates easy interchangeability of the pucks 130, allowing users to swap out devices quickly and securely.

The mounting system in an embodiment incorporates a specialized receptacle designed to complement and securely hold the interchangeable pucks 130. In the preferred embodiment, this receptacle is an integral part of the mounting system's body, constructed from the same high-grade commercial urethane material used for the flexible arms 110. This design choice ensures consistency in material properties throughout the system, enhancing overall durability and functionality.

The urethane composition of the receptacle in an embodiment provides a unique combination of flexibility and retention strength. The flexibility allows the receptacle to deform slightly as the interchangeable puck 130 is inserted, creating a snug fit that securely holds the interchangeable puck 130 in place during use. This flexible yet secure connection is crucial for maintaining the stability of attached devices, especially in dynamic environments or during active use.

The polygonal interchangeable puck 130 design in an exemplary embodiment is implemented with various configurations to optimize functionality and manufacturing efficiency. The interchangeable puck 130 can adopt any polygonal form with three or more sides, though a 12-sided (dodecagon) configuration provides clear illustrative benefits. The number of sides can range from 3 (triangle) to higher integers, with preferred embodiments including 4 (square), 6 (hexagon), 8 (octagon), 10 (decagon), 12 (dodecagon), 16, and 20 sides for specialized applications.

The polygonal interchangeable pucks 130 in varying embodiments are implemented as either regular configurations with equal sides and angles, or irregular configurations with varying sides and angles. Regular polygons provide predictable geometry and balanced force distribution, while irregular polygons can be tailored for specific functional or ergonomic requirements. The dimensions are defined by key parameters including the diameter of the circumscribed circle (D) which determines compatibility with the receptacle, the inscribed circle diameter (d) for device attachment surface area, and the side length (s) which relates to the diameter by s=D\*sin(π/n) for regular polygons.

The facets (sides) of the polygon forming the interchangeable puck 130 in varying embodiments is implemented with flat, curved (convex or concave), or textured surfaces to enhance grip or aesthetics. Edges between facets can be sharp, rounded, or chamfered to improve handling and reduce wear. The central area can incorporate an aperture for cable routing and alignment features, or remain solid for adhesive attachment or component embedding.

The polygonal configuration of the interchangeable puck 130 provides several functional benefits over circular designs in alternative embodiments. The faceted surfaces offer increased points of contact and friction, improving grip and reducing slippage risk in dynamic environments. Higher numbers of sides generally provide better grip characteristics. The hexagonal shape specifically prevents loosening or slipping when locked with corresponding hexagonal components.

Manufacturing considerations for the polygonal interchangeable puck 130 in an embodiment includes material selection between ABS polyurethane and reinforced composites. Injection molding provides cost-effective mass production of complex polygonal shapes, while machining offers greater precision for smaller production runs. 3D printing enables prototyping and custom puck creation with intricate geometries. Surface finishing processes can enhance appearance, grip, and durability.

The polygonal interchangeable puck 130 in an exemplary embodiment integrates with other system features including retention grooves for receptacle engagement, embedded magnets for direct ferromagnetic surface attachment, and interchangeable inserts for different attachment mechanisms. Further embodiments can incorporate variable facet angles for specific gripping requirements, hollow interiors for weight reduction or component housing, and articulated designs with hinges or joints for additional positioning freedom.

The specific number of sides, shape dimensions, and material selection for each interchangeable puck 130 in varying embodiments is optimized based on intended use case requirements and desired balance between functionality, aesthetics, and manufacturability. Precise tolerances are crucial for ensuring proper fit and function within the mounting system's receptacle, with manufacturing processes selected to consistently achieve these tolerances.

The polygonal interchangeable puck 130 design in an embodiment enables seamless integration of multiple functional features to enhance versatility and performance. The retention groove that engages with the receptacle can be precisely incorporated into the polygonal geometry while maintaining the structural integrity of the faceted design. This groove encircles the puck's perimeter and is engineered to securely lock the puck into place once attached to the mounting system, preventing unwanted rotation or slippage during use.

The interchangeable puck 130 in an embodiment incorporates one or more embedded magnets within its structure regardless of the specific polygonal configuration selected. These embedded magnets enable direct attachment to ferromagnetic surfaces while maintaining the geometric advantages of the polygonal shape. The placement of magnets can be optimized based on the number and arrangement of facets of the interchangeable puck 130 to ensure balanced magnetic force distribution.

The central portion of the interchangeable puck 130 in an embodiment comprises a modular design that accepts various interchangeable inserts for different attachment mechanisms. This includes threaded inserts for camera mounting, GoPro-compatible mounts, and other specialized attachment interfaces. The polygonal shape provides stable alignment for these inserts while maintaining the overall structural integrity of the interchangeable puck 130.

For specialized applications, interchangeable puck 130 in an embodiment are manufactured with non-uniform facet angles. These variable angles enable specific gripping or alignment requirements while maintaining compatibility with the mounting system's receptacle. The facet angles can be precisely engineered to provide optimal contact and grip for particular use cases.

Hollow interchangeable puck 130 configurations in an embodiment reduce overall weight while providing space for internal components. The hollow design maintains structural rigidity through strategic internal support structures while creating cavities for housing electronics, additional magnets, or other functional elements. This approach optimizes the weight-to-strength ratio of the puck while expanding its capabilities.

Articulated interchangeable puck 130 designs in an embodiment incorporate hinges or joints that enable additional degrees of freedom for device positioning. These articulation points can be integrated into the polygonal structure while maintaining secure engagement with the receptacle. The joints provide controlled movement for precise device orientation while preserving the puck's core mounting functionality.

The interchangeable puck 130 design in accordance with an embodiment allows for integration of specialized features like central apertures for cable routing or alignment mechanisms. These features can be incorporated while maintaining the polygonal geometry and structural integrity of the puck 130. The modular nature of the design enables various combinations of features to be implemented based on specific application requirements.

The interchangeable puck 130 incorporates adaptable locking mechanisms to accommodate various polygonal configurations. A primary implementation utilizes a continuous retention groove 131 that encircles the perimeter of the interchangeable puck 130, engaging with complementary features in the receptacle such as raised lips, pawls, or flexible rings. The groove profile can be optimized with dovetail, square, or rounded geometries to ensure secure locking while maintaining compatibility across different polygonal shapes.

For specific polygonal configurations like hexagonal or octagonal implementations of interchangeable puck 130 in an embodiment, facet-specific locking mechanisms can be incorporated into the interchangeable puck 130 and/or its receptacle. The receptacle includes inward-facing protrusions that align with corresponding facets on the interchangeable puck 130, preventing rotation while providing positive engagement. This approach is particularly effective for applications requiring precise orientation control.

The interchangeable puck 130 can implement central locking features in an embodiment through an aperture or specialized mechanism in its center. This enables rotating cam or bayonet-style locks to engage with corresponding receptacle features, particularly beneficial for configurations designed for single-orientation attachment or those incorporating central voids for cable routing or other purposes.

Passive locking implementations allow the interchangeable puck 130 in an embodiment to automatically secure upon insertion into the receptacle. This includes snap-fit mechanisms where flexible elements in the receptacle engage the retention groove 131, and ball-detent systems utilizing spring-loaded balls that engage corresponding detents in the interchangeable puck 130.

Active locking mechanisms for the interchangeable puck 130 in an embodiment require deliberate engagement actions. These include rotating cam systems, adjustable locking rings, and button-release mechanisms. The locking force can be made variable through adjustable mechanisms like screws or cams, allowing users to optimize holding strength for specific applications.

The locking features in an embodiment integrate seamlessly with the polygonal geometry of interchangeable puck 130. The retention groove 131 can be incorporated as an integral part of the faceted design rather than a separate feature. In some implementations, specific facets serve as primary locking surfaces, eliminating the need for additional grooves while maintaining secure engagement.

Concealed locking mechanisms can be implemented in an embodiment within the interchangeable puck 130 or receptacle to maintain clean aesthetics. The system supports modular locking implementations where different security modules can interface with a common interchangeable puck 130 design, providing scalable security options based on application requirements.

The interchangeable puck 130 in varying embodiments is implemented in several specific configurations that demonstrate the versatility of the locking mechanism design. In a dodecagonal implementation, the interchangeable puck 130 features a continuous dovetail-profile retention groove 131 around its perimeter that engages with a flexible ring integrated into the receptacle. Upon insertion, the ring deforms elastically to allow passage of the interchangeable puck 130 before returning to its original shape to create a secure snap-fit lock within the retention groove 131.

For hexagonal configurations, the interchangeable puck 130 in an embodiment incorporates inward-facing protrusions on its facets that correspond with matching recesses engineered into the receptacle. When the interchangeable puck 130 is inserted and rotated, these protrusions engage with the recesses to create a positive mechanical lock that prevents both linear and rotational movement.

A triangular implementation of interchangeable puck 130 in an embodiment utilizes a central aperture designed to interface with a bayonet-style locking mechanism in the receptacle. The bayonet lock engages when the interchangeable puck 130 is inserted and rotated, providing secure retention while enabling quick release when needed.

The interchangeable puck 130 demonstrates distinct advantages in both round and polygonal configurations. The polygonal design offers increased grip through faceted surfaces that provide more points of contact and friction compared to circular designs. This enhanced grip reduces the risk of slippage or rotation, particularly in dynamic environments. The hexagonal configuration specifically prevents loosening when locked with corresponding hexagonal components, providing an advantage over circular designs.

The implementation of different geometric configurations in varying embodiments maintains core functionality through standardized features. Each configuration, whether polygonal or round, incorporates the retention groove 131 that enables secure engagement with the receptacle. For polygonal implementations, the dimensions are defined by key parameters including the circumscribed circle diameter (D) for receptacle compatibility, the inscribed circle diameter (d) for attachment surface area, and the side length (s) which relates to the diameter by s=D\*sin(π/n) for regular polygons.

The core functionality in varying embodiments remains consistent across different shapes through several key design elements. The retention groove 131 maintains uniform engagement with the receptacle regardless of the puck's exterior geometry. The central mounting features, whether for camera attachment, magnetic coupling, or other purposes, function identically across different shape configurations. The polygonal shapes can incorporate the same locking mechanisms as round configurations, including snap-fit engagement, bayonet locks, and facet-specific locking features.

Each geometric configuration in varying embodiments is manufactured using standard processes including injection molding for high-volume production or machining for smaller runs. The polygonal designs maintain compatibility with existing mounting system components while offering enhanced grip and rotation prevention through their faceted surfaces. Surface finishing processes can be applied consistently across all configurations to enhance appearance, grip, and durability.

The system's adaptability to different geometric configurations in varying embodiments enables optimization for specific use cases while maintaining core mounting and attachment capabilities. Whether implemented as a dodecagon, hexagon, or other polygon, the interchangeable puck 130 preserves its essential functions of secure device retention, magnetic coupling when applicable, and reliable engagement with the mounting system's receptacle.

The locking mechanisms for all configurations of interchangeable puck 130 in an embodiment are engineered for intuitive operation even in challenging conditions. The engagement and disengagement actions can be performed while wearing gloves and require minimal dexterity, making the system practical for outdoor and industrial applications.

The durability of the locking mechanism in an embodiment is ensured through material selection and engineering design. The components are constructed from high-grade materials like ABS polyurethane and reinforced composites that maintain their mechanical properties through repeated use cycles. The locking features are designed to distribute forces evenly to prevent wear concentration and maintain consistent locking force over time.

Manufacturing considerations are integrated into the design of interchangeable puck 130 and its locking mechanisms in accordance with embodiments. The components are engineered to be produced using standard injection molding processes for cost-effective high-volume production. The geometries avoid complex undercuts or features that would require expensive tooling or assembly processes. For smaller production runs, the design supports machining from solid materials while maintaining essential functional characteristics.

The receptacle features a groove engagement mechanism specifically designed to interact with the retention groove on the puck. This mechanism, which may consist of a raised lip or a series of flexible clips, aligns with and fits snugly into the puck's retention groove. The urethane material's inherent flexibility allows these engagement features to deform slightly during puck insertion and removal, providing a secure lock while still allowing for easy interchangeability of pucks. The receptacle is made from the same flexible urethane material as the rest of the main body, ensuring compatibility and durability. This design choice allows the receptacle to deform slightly as the puck is inserted, creating a snug fit that securely holds the puck in place during use.

A key innovation in the receptacle design in accordance with the preferred embodiment is its ability to allow rotational adjustment of the inserted puck. The urethane material's properties are carefully calibrated to provide enough resistance to hold the puck at a desired angle during operation, while still allowing for adjustment with a small amount of applied force. This feature significantly enhances the versatility of the mounting system, enabling users to fine-tune the orientation of attached devices without needing to reposition the entire mount.

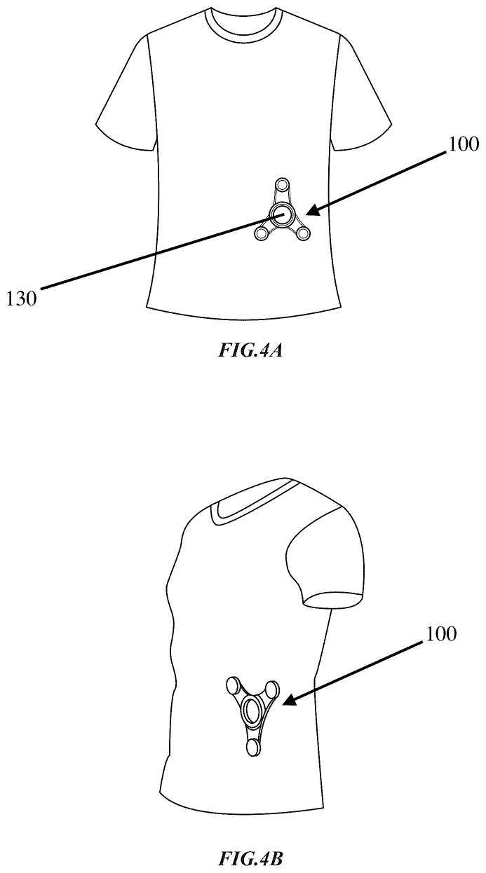

The receptacle and mount are strategically integrated in association with or within the main body 100 at the intersection point 111 of the flexible arms 110 in accordance with an embodiment, as depicted in FIG. 4A. This low-profile design maintains the overall sleekness of the mount while leveraging the stability provided by the arms'configuration. Importantly, this placement optimizes the utilization of magnetic fields from the embedded magnets 115 in the flexible arms 110. By positioning the receptacle and mount at these intersection point 111, the system avoids placing the puck 130 between the magnets of corresponding bodies, which could interfere with the direct magnetic forces between the flexible arms 110. This design enhances the overall holding power of the system while still providing a secure and adjustable attachment point for various devices.

The combination of the urethane material of the main body 100, the groove engagement mechanism, and the strategic placement of the receptacle creates a mounting system that is not only secure and durable but also highly adaptable to various use cases in accordance with an embodiment. The ability to easily insert, securely hold, and adjust the angle of attached devices makes this system suitable for a wide range of applications, from action sports photography to industrial tool mounting.

In the preferred embodiment, inserting the puck 130 into the receptacle is straightforward and user-friendly. The puck 130 is aligned with the receptacle forming a part of the main body 100 at the intersection point 111 in an embodiment, and a slight pressure is applied until the clips or lip of the receptacle engage with the retention groove on the puck 130. This engagement in an embodiment produces a click or tactile feedback, indicating that the puck 130 is securely locked in place. Removal involves applying a reverse pressure or activating a release mechanism, which disengages the puck 130 from the receptacle for easy removal or interchange. Once engaged, the puck 130 is held firmly within the receptacle, with minimal play or movement. This secure fit ensures that any device 300 attached to the puck 130, such as a camera or light, remains stable and correctly aligned, providing optimal functionality and reducing the risk of damage due to vibrations or impacts.

In the preferred embodiment, the puck 130 is strategically placed within a mount and/or receptacle of a main body 100 of the system at the intersection point 111 of the flexible arms 110 in accordance with an intended use. Positioning a puck 130 at the intersection point 111 of the flexible arms 110 distributes the weight of the attached devices evenly across the structure of the mounting system. This distribution helps maintain balance and reduces strain on any single flexible arm, enhancing the overall stability of the mounting system. The central placement of the puck 130 upon a receptacle strategically located at the intersection point 111 allows for the attachment of devices in a manner that is both aesthetically pleasing and functionally effective. In accordance with intended uses, devices 300 attached can be oriented in multiple directions, providing flexibility in how cameras, lights, or tools affixed to the receptacle and/or the mount are used.

The system in various embodiments is designed to allow for interchangeability of pucks 130, enabling users to switch between different puck 130 configurations with ease. Each puck 130, regardless of its specific configuration, is designed to fit securely into the same receptacle on the main body 100 of the system. In the preferred embodiment, to change from one configuration to another, a user simply removes the currently attached puck 130 by disengaging it from the receptacle's locking mechanism, which typically involves a slight pressure or a release action. The new puck, whether designed to retain a camera, a tablet, a RFID tag, an Apple AirTag, or another object, can then be inserted into the same receptacle. This puck is secured in place by the receptacle's engagement mechanism, clicking into the retention groove that encircles the puck's perimeter. This design not only ensures a secure and stable attachment for a variety of devices but also enhances the flexibility and utility of the mounting aspects of the system, making it adaptable to a wide range of applications and user needs.

The puck 130 of the preferred embodiment of the system is designed with versatility in mind, accommodating a wide range of devices 300 and functionalities through various interchangeable puck configurations. Each configuration is specifically tailored to enhance the utility of the puck 130 for different applications, ensuring broad usability from personal devices to professional equipment.

One configuration of the puck 130 features a puck 130 embedded with a magnet as depicted in FIG. 4A, which is ideal for attaching to any ferromagnetic surface, or retention of a metallic object upon the puck. This magnet is centrally embedded to maximize effectiveness and is coated to prevent corrosion and wear, making it useful in settings like automotive workshops for holding tools, or kitchens for securing utensils.

Another configuration of the puck 130 features a puck 130 comprising ¼-20 threaded insert, making it suitable for attaching cameras or any device that utilizes this common tripod mount thread. This design ensures devices are securely fastened and can be easily adjusted, catering to photographers, videographers, and hobbyists who need to quickly and securely mount cameras or lights in diverse settings.

Another configuration of the puck 130 comprises a puck 130 designed specifically for iPads or similar tablets. This puck comprises a custom-fitted cradle or clamp that securely holds the tablet, often adjustable for optimal viewing angles. This makes it perfect for use in educational environments, presentations, or any setting where mobile and adjustable platforms for information display are required.

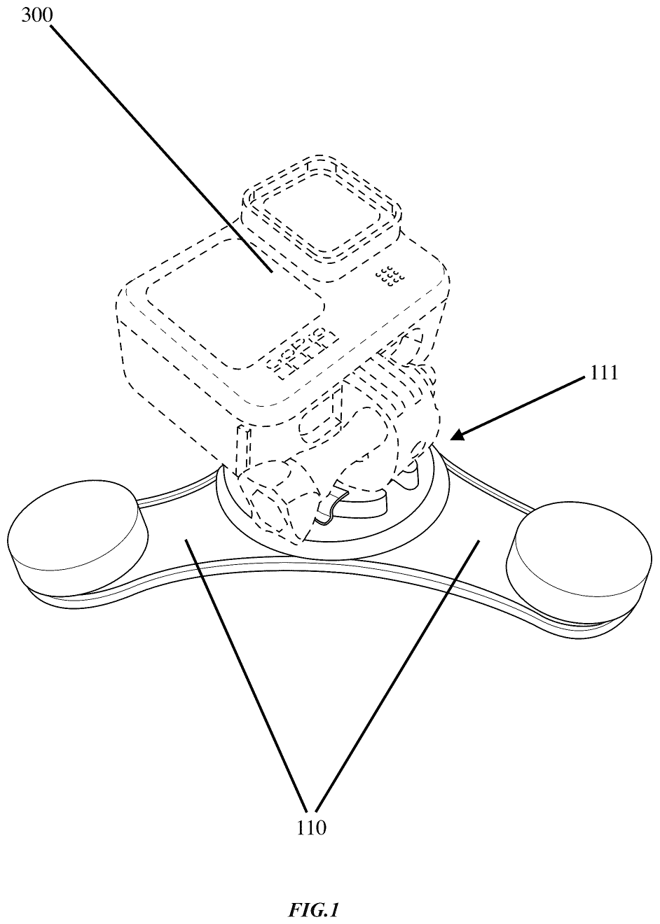

Another configuration of the puck 130 in an embodiment features a puck comprising a GoPro mount puck 130 tailored to fit GoPro cameras, as depicted by FIG. 1, FIG. 6A and FIG. 6B. This puck 130 includes a mount compatible with GoPro's proprietary attachment system, allowing for secure and stable camera placement essential for capturing action shots and dynamic filming environments.

Additionally, in another configuration the puck comprises a receptacle specifically designed to hold an Apple AirTag or other similar RFID tags. It is particularly beneficial in logistics, personal security, or any scenario where item tracking is necessary. In an exemplary embodiment, the mounting system incorporates an innovative configuration for the puck that enhances its functionality beyond simple device attachment. In this configuration, the puck comprises a receptacle specifically designed to hold an Apple AirTag or other similar RFID tags. This design ensures that the tag is snugly fit and remains accessible and functional, providing a dual-purpose solution for both mounting and tracking. The integration of an AirTag or RFID tag into the puck serves multiple practical purposes. It allows for easy device recovery in scenarios where the mounted device becomes detached due to the system's safety release feature, such as during skiing accidents. In industrial or mechanical settings, the AirTag functionality can be used as a safety measure, allowing technicians to verify that no tools or mounts have been inadvertently left behind in areas like engine bays. The AirTag-enabled puck is also ideal for tracking valuable equipment, personal items, or even pets in various environments, making it particularly beneficial in logistics, personal security, or any scenario where item tracking is necessary. Furthermore, the AirTag can be added to the back of any puck configuration, allowing this tracking functionality to be combined with other mounting purposes. This means that cameras, lights, or other devices can be both securely mounted and easily trackable. This configuration demonstrates the system's adaptability to various use cases, combining the secure mounting capabilities with advanced tracking technology. It addresses practical concerns such as equipment loss prevention and safety verification, further enhancing the utility of the mounting system across diverse applications from recreational activities to professional and industrial use.

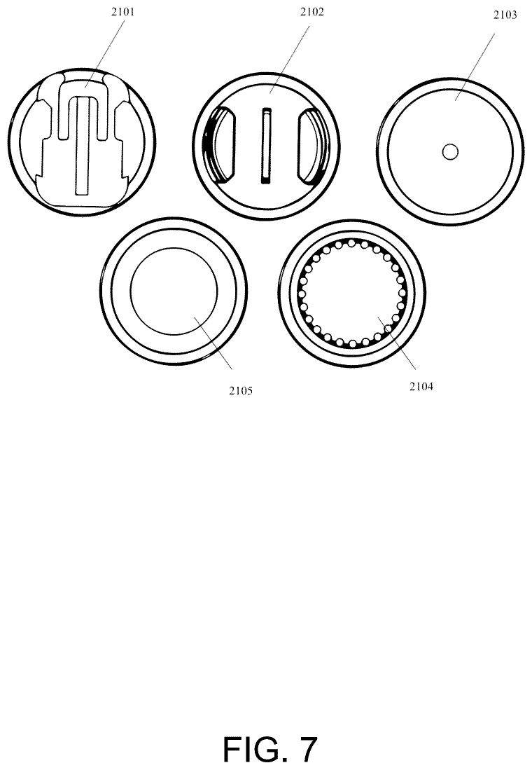

In various embodiments the puck 130 is constructed from high-impact, durable materials such as ABS polyurethane or reinforced composites to withstand various environmental conditions and usage scenarios. The design of each puck 130 considers the weight, balance, and operational requirements of the devices they support, incorporating features like water resistance, shock absorption, and ease of device insertion and removal. For pucks 130 with embedded magnets, the strength and type of magnet are chosen based on the expected use and the weight of the objects to be supported, with shielding included to prevent magnetic interference with device operations. Various embodiments of the pucks in a variety of configurations are depicted by FIG. 7. In accordance with an embodiment, a puck is configured to comprise a male GoPro attachment 2101. In accordance with an embodiment, a puck is configured to comprise a female GoPro attachment 2102. In accordance with an embodiment, a puck is configured to comprise a ¼-20 screw 2103, for example to accommodate various cameras. In accordance with an embodiment, a puck is configured to comprise a lanyard 2104. In accordance with an embodiment, a puck is configured to comprise a magnet 2105, which is intended to retain metallic or other magnetically compatible items via magnetic force.

This diverse range of puck 130 configurations within the mounting system demonstrates its adaptability and functionality, ensuring that the system can be employed effectively in a variety of environments and for multiple purposes, enhancing the system's overall utility and appeal.

In an exemplary use, the first body 100 is placed on the exterior of the clothing 400. Its flexible arms 110 can be adjusted to conform to the outer surface of the clothing 400, ensuring it follows the contours and curves of the fabric and the wearer's body shape. Correspondingly, the second body 120 is placed directly opposite the first body 100 but on the interior of the clothing. It mirrors the position and orientation of the first body 100, ensuring that the magnets in both bodies are aligned to create a strong magnetic force across the fabric.

The magnets embedded within the arms of the main body 115 placed opposite individual opposing magnets 125 or an opposing mirrored body comprising embedded magnets 120 generate a magnetic field strong enough to penetrate through the clothing 400, creating a secure attachment without the need for piercing or clamping mechanisms. This method ensures that the mount remains securely in place, even during vigorous movements or in windy conditions, yet can be easily repositioned or removed without leaving marks or damage to the clothing.

A primary application of this dual-body magnetic attachment system in association with its preferred embodiment is for active scenarios, such as sports or outdoor activities, where securing a camera or device to clothing is desirable for hands-free operation. For example, the system has been observed by the inventor to be useful in scenarios involving active filming. For instance, an individual participating in a cycling event can use this mounting system to secure an action camera to their jersey. The first mirrored body with its flexible arms 110 is adjusted on the exterior of the jersey, while the second mirrored body is placed inside, directly opposite the first. The magnetic force between the two bodies through the jersey fabric holds the camera securely in place, allowing for stable filming without the risk of the mount shifting or detaching.

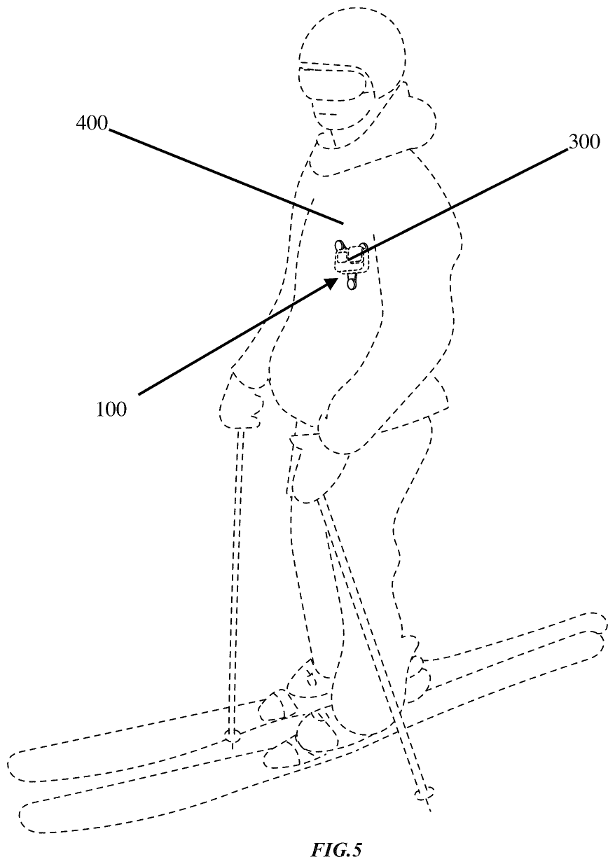

Another exemplary use involves placement of the mount on clothing worn by a downhill skier, as depicted in FIG. 5, prior to engaging in such activity. In the context of downhill skiing, where dynamic movement and exposure to elements are constant, the dual-body magnetic attachment system offers a practical and robust solution for mounting devices such as action cameras or navigational aids directly onto the skier's clothing.

Prior to skiing, in an exemplary use, the skier attaches the first body, in this instance the exterior body, with its flexible arms 110 to the exterior of their ski jacket 400, as depicted by FIG. 5. This body is adjusted to conform to the desired mounting location, such as on the chest or shoulder, which provides an optimal angle for filming or visibility. The second body, in this instance the interior body, is then placed on the inside of the ski jacket, directly opposite the first body. The alignment of the magnets in both bodies ensures a strong magnetic connection through the layers of the ski jacket. Once the bodies are in place, the skier can attach the desired device, such as an action camera, to the mount. For example, a camera may be secured in the puck designed for this purpose, forming a part of the exterior body in an embodiment. In an alternative method of use, the skier can attach the desired device prior to attaching the mount to clothing. The magnetic force between the two bodies keeps the mount stable and securely attached to the jacket, even during vigorous skiing and jumps. This stability is crucial for ensuring that the footage captured by the camera is clear and steady. The present inventor has observed the advantage of adjustability in this exemplary context. It is a teaching of the invention that if the skier needs to adjust the angle of the camera or switch the device, they can easily access the mount without removing their gloves or jacket. The system further provides the benefit of quick adjustments, which is highly beneficial in the cold and fast-paced environments of downhill skiing. Moreover, since the system uses magnetic attachment instead of clips or straps, it minimizes any discomfort and safety risks that might be caused by more rigid or sharply-edged mounting systems. The flexible arms 110 of the mount also ensure that it does not interfere with the skier's movements or safety gear.

In exemplary embodiments of the invention, the mounting system's versatility and adaptability in skiing scenarios can be further enhanced through the incorporation of additional magnet attachment points on various parts of the skier's gear 400. This innovative feature allows for quick and easy repositioning of the mount main body 100, significantly expanding the range of camera angles and mounting options available to the user. The system can be designed to include compatible magnetic attachment points on key pieces of equipment, such as the skier's helmet and skis, in addition to the primary mounting location on the ski jacket 400 in accordance with an intended use. These additional attachment points are engineered to match the magnetic strength and configuration of the mount's main body's 100 flexible arms 110, ensuring a secure and stable connection regardless of the chosen location.

The inclusion of these multiple attachment points offers several advantages in exemplary embodiments. The skier can swiftly move the mount body between different attachment points on their gear, allowing for quick transitions between, for example, a chest-mounted view to a helmet-mounted perspective, or even a ski-mounted angle for capturing ground-level footage. This rapid angle change capability is particularly valuable in the dynamic and time-sensitive environment of skiing. By enabling quick and tool-free repositioning, the system reduces the need for the skier to manipulate small components or make complex adjustments while on the slopes, minimizing distractions and potential safety risks associated with adjusting equipment in challenging conditions.

In exemplary embodiments, the ability to easily switch between multiple mounting points provides skiers with a wider range of creative filming options. They can capture their run from various perspectives without the need for multiple camera setups or time-consuming equipment changes. As lighting conditions or skiing terrain change throughout the day, the skier can quickly adapt their camera position to capture the best possible footage. This flexibility is invaluable for both amateur enthusiasts and professional videographers. The magnetic attachment system ensures that these additional mounting points can be seamlessly integrated into safety equipment like helmets without compromising their protective function. The flexible and low-profile nature of the mount maintains the integrity and comfort of the safety gear.

The implementation of these additional attachment points in exemplary embodiments maintains the core benefits of the original mounting system, including the strong magnetic connection, the flexibility to conform to various surfaces, and the safety features that allow the mount to detach under excessive force. This expanded functionality further distinguishes the system from traditional mounting solutions, offering users an unprecedented level of versatility and ease of use in challenging winter sports environments. The system's design facilitates quick, easy, and safe changes in camera angles, enhancing the overall user experience and creative possibilities for skiers and other winter sports enthusiasts. In various embodiments, to facilitate rapid transition of the mounting system to various points upon a wearer or equipment, the clothing of a wearer or articles of equipment may feature pre-positioned individual opposing magnets placed opposite the magnets 115 embedded within the flexible arms 110 of a main body 100.

The magnetic attachment system designed for this mount offers a significant advantage in terms of its non-invasive nature. Unlike traditional mounts that may require drilling, sewing, or the use of adhesives that could potentially damage the fabric of clothing, this magnetic system preserves the integrity of the clothing. The magnets provide a strong hold without the need for permanent alterations or residues that could stain or weaken the fabric. This feature is particularly beneficial for users who need to mount devices on expensive or delicate garments, such as performance wear or professional uniforms, where maintaining the garment's condition is essential.

Another observed advantage associated with embodiments of the invention is flexibility and ease of use. These are critical in dynamic environments where conditions or requirements can change rapidly. The magnetic attachment system allows for unprecedented ease in making adjustments or removing the mount entirely. Users can reposition the mount in seconds without tools or additional help. This capability is invaluable in scenarios such as news reporting, outdoor photography, or sports, where quick adaptation to new angles or positions can make a difference in the quality of the output. Additionally, the ease of removal ensures that users can swiftly detach the device and mount when no longer needed, enhancing convenience and reducing the time spent on equipment management.

In accordance with the preferred embodiment, the flexible arms 110 of the mounting system incorporate specific material and design characteristics that enable optimal performance across various applications. The arms are constructed from commercial grade urethane material carefully selected to provide ideal flexibility while maintaining structural integrity. This specialized composition allows each arm to achieve a full 180-degree range of motion while retaining sufficient rigidity to support attached devices and maintain consistent magnetic alignment.

The material properties of the flexible arms 110 in an embodiment are precisely engineered to enable comprehensive wrapping and conforming capabilities around diverse objects and surfaces. The commercial grade urethane demonstrates specific performance characteristics including a Shore hardness rating that balances flexibility with structural stability, preventing unwanted sagging while enabling controlled bending. The material maintains a tensile strength sufficient to support up to 5 pounds of force when magnetically engaged with an opposing body. Additionally, the urethane composition remains stable and maintains consistent flexibility across a temperature range from −20¬∞F to 140¬∞F, incorporating UV-resistant properties to prevent material degradation in outdoor applications.

The gripping effectiveness of the system in an embodiment is directly related to the configuration and number of flexible arms 110 employed. The preferred embodiment utilizes a tri-arm design that optimizes stability and adaptability by distributing magnetic force and mechanical tension evenly across the mounting surface. This three-arm configuration creates balanced support points that work in concert with the embedded magnets to generate consistent clamping force when aligned with opposing bodies. While alternative embodiments may incorporate different numbers of arms for specific applications, the tri-arm design has been determined to provide optimal performance across the broadest range of use cases.

The flexible arms 110 in an embodiment work synergistically with the embedded magnetic components to create secure attachment points across varied surfaces. When opposing bodies are aligned, the flexibility of the flexible arms 110 allows them to conform to irregular surfaces while maintaining proper magnetic alignment, ensuring consistent holding force across the entire contact area. This integration of flexibility and magnetic attraction enables effective gripping on diverse surfaces including textiles, equipment surfaces, and irregularly shaped objects.

The dimensional specifications of each flexible arm 110 in an embodiment are carefully engineered to achieve an optimal balance between flexibility and stability. The flexible arms 110 in an exemplary embodiment are proportioned with specific length and diameter measurements that provide sufficient reach for wrapping around objects while maintaining a profile conducive to easy manipulation. This precise dimensioning ensures the arms can flex freely through their full range of motion without compromising their ability to maintain position under load or sacrificing magnetic holding power.

The system's flexible arms 110 demonstrate particular effectiveness in dynamic environments where traditional rigid mounting solutions prove inadequate. The arms'ability to conform to varied surfaces while maintaining magnetic alignment allows for secure attachment across a wide range of applications, from sporting equipment to industrial machinery. This adaptability is achieved without sacrificing the structural integrity necessary for supporting attached devices, providing a mounting solution that combines security with versatility.

The combination of flexible arms 110 and magnetic attachment expands the possibilities for device placement on clothing or other objects. The flexible arms 110 of the bodies associated with the system can be manipulated to conform to various parts of the wearer's body, whether it's the sleeve, chest, back, or even a hat. This versatility ensures that users can optimize the placement of the camera or device based on their specific needs and the requirements of the activity at hand. For instance, a cyclist might prefer the mount on the back to capture rear-facing footage, while a climber might place it on the helmet for an upward perspective. The ability to easily adjust the placement not only enhances the functionality of the mount but also maximizes the effectiveness of the device being used.

The flexible arms of the mounting system 110 in an embodiment can be implemented with various dimensions to accommodate different use cases and requirements. For shorter-range applications requiring close-proximity mounting and lighter devices, the arms can be constructed at approximately 4 inches in length. Medium-length arms of 6 inches provide versatile general-purpose use, while longer 8-inch arms enable encircling of larger objects and more flexible positioning options. For maximum adaptability, the arms can be implemented with telescoping or articulated designs that allow length adjustment based on specific needs.

The diameter and thickness specifications of the flexible arms 110 in a preferred embodiment are carefully engineered to balance manipulation ease with structural integrity. Thin arms with 0.5-inch diameter maximize flexibility and are optimal for lighter devices, while standard 0.75-inch diameter arms provide balanced flexibility and strength for general applications. For more demanding uses requiring support of heavier devices, thicker 1-inch diameter arms can be implemented. A flat, ribbon-like arm configuration measuring 0.25 inches thick by 1 inch wide offers alternative flexibility characteristics and improved conformity to curved surfaces.

The material composition of the flexible arms 110 in an embodiment can be implemented using several alternative materials beyond commercial urethane to achieve specific performance characteristics. Silicone rubber provides excellent flexibility, high-temperature resistance, and UV resistance while maintaining good grip properties. Different grades of silicone can be selected to fine-tune flexibility requirements. Thermoplastic elastomers (TPEs) offer balanced flexibility and strength, with specific formulations available for temperature resistance or chemical resistance. These include thermoplastic polyurethane (TPU) for improved processability and copolyester elastomers (COPE) for flexibility and resilience.

For applications requiring enhanced strength while maintaining flexibility, reinforced polymer implementations can be utilized in the composition of the flexible arms 110 in an embodiment. Fiberglass-reinforced polymers significantly increase strength and stiffness while preserving flexibility. Carbon fiber-reinforced polymers offer even higher strength-to-weight ratios, though at increased cost. Kevlar-reinforced polymers provide exceptional tear resistance and impact strength for high-stress applications.

Specialized implementations of the flexible arms 110 in an alternative embodiment can incorporate shape-memory alloys like Nitinol for automatic adjustment capabilities. Elastomeric foams can be integrated into the arms or used as core material to provide cushioning and vibration damping, with different foam densities selected to adjust flexibility and support characteristics. Hybrid material implementations combining flexible cores like silicone with rigid overmolded reinforced polymers can provide optimal combinations of flexibility and strength.

The selection of materials and specifications of the flexible arms 110 in an embodiment must consider key performance factors including flexibility for wrapping around objects, strength to support device weight, magnetic compatibility, environmental resistance to temperature/UV/moisture/chemicals, cost considerations, and manufacturing process compatibility. The implementation must ensure the arms maintain sufficient flexibility to wrap around objects while providing adequate strength to prevent sagging under load.

The flexible arm 110 configuration can be implemented with varying numbers of arms beyond the preferred three-arm embodiment. Two-arm configurations provide simpler and lighter implementations, while four-arm configurations offer increased stability. The arrangement of arms can be varied between radiating from a central point or arranged linearly depending on intended use cases.

In various embodiments, the system comprising flexible arms 110 with embedded magnets, allows it to adapt to a multitude of environments and purposes beyond mounting to clothing. One example of use involves machinery maintenance. In such exemplary use of the system, the mount can be used in industrial settings to attach diagnostic tools or lights to machinery. Its ability to conform to metallic surfaces of complex machinery allows maintenance personnel to work hands-free, enhancing safety and efficiency. For instance, during a turbine inspection, the mount can securely hold a flashlight or a camera to record the condition of the machinery, providing stable footage despite the vibrations and movements typical in such environments.

The mounting system can implement various configurations beyond the preferred three flexible arms 110 design. A two flexible arms 110 configuration provides a simpler and lighter implementation suitable for applications with lower weight requirements, while a four flexible arms 110 configuration offers increased stability through additional magnetic contact points. The flexible arms 110 can be arranged either radiating from a central point or in a linear arrangement depending on intended use cases.

The relationship between flexible arms 110 design and magnetic strength is optimized through strategic placement of magnets. Each flexible arm 110 contains embedded magnets that provide approximately 2.5 lbs of holding force individually. When multiple flexible arms 110 are used in conjunction, they collectively provide about 5 pounds of total holding force. This magnetic strength can be enhanced through stacking of additional bodies or magnetic discs for force multiplication, increasing the total holding force by up to 80%.

The flexible arms 110 configuration directly impacts overall system performance through the distribution of magnetic forces and mechanical tension. The preferred tri-arm design using flexible arms 110 optimizes stability by distributing forces evenly across the mounting surface. The flexible arms 110 work synergistically with the embedded magnets to create secure attachment points, with the flexibility allowing conformity to irregular surfaces while maintaining proper magnetic alignment.

The mounting system in a preferred embodiment implements between two and ten flexible arms 110 radiating from a central intersection point, with each configuration offering specific advantages. A two-arm configuration provides a simpler and lighter implementation suitable for applications with lower weight requirements, while configurations with additional arms offer increased stability through additional magnetic contact points.

The flexible arms 110 in varying embodiments are arranged radiating from a central intersection point in various numerical configurations, with each arm containing embedded magnets providing approximately 2.5 lbs of holding force individually. When multiple arms are used in conjunction, they collectively provide increased holding force, with the total force scaling based on the number of arms implemented.

The number of flexible arms 110 in varying embodiments directly impacts the distribution of magnetic forces and mechanical tension across the mounting surface. While a three-arm configuration represents the preferred embodiment for optimal stability, alternative configurations using between two and ten arms can be implemented based on specific application requirements. The flexible arms 110 in an embodiment work synergistically with their embedded magnets to create secure attachment points, with the flexibility allowing conformity to irregular surfaces while maintaining proper magnetic alignment regardless of the number of arms utilized.

Each flexible arm 110 in any configuration between two and ten arms maintains the same core specifications, including in embodiments length options ranging from 4 inches for close-proximity mounting to 24 inches for larger objects. In varying embodiments, the flexible arms 110 thickness options range from 0.2 inches for maximum flexibility to 2 inches for demanding applications. The flexible arms 110 in varying embodiments are constructed from materials including commercial grade urethane, silicone rubber, thermoplastic elastomers, or reinforced polymers to maintain consistent performance characteristics across different numerical configurations.

The arrangement of multiple arms radiating from a central intersection point enables the system to distribute forces evenly while maintaining the ability to conform to various surface geometries. This adaptability is preserved whether implementing minimal two-arm configurations for lightweight applications or expanded configurations up to ten arms for maximum stability and holding power.

Manufacturing specifications for flexible arms 110 can be implemented using various materials and processes. The flexible arms 110 can be constructed in different lengths ranging from 4 inches for close-proximity mounting to 8 inches for larger objects, with variable diameter options from 0.5 inches for maximum flexibility to 1 inch for demanding applications. Alternative materials for flexible arms 110 include silicone rubber for excellent flexibility and temperature resistance, thermoplastic elastomers (TPEs) for balanced properties, and reinforced polymers incorporating fiberglass, carbon fiber, or Kevlar for enhanced strength while maintaining flexibility.

The manufacturing process for flexible arms 110 must account for specific dimensional requirements including length allowing sufficient reach to encircle objects and diameter optimized for manipulation while preventing sagging. The process can incorporate telescoping or articulated designs for adjustable length capabilities in flexible arms 110. Surface finishing and material treatments ensure environmental resistance to temperature, UV exposure, moisture, and chemicals.

In another exemplary use, on construction sites, the system due to the versatility of the flexible arms 110 can be wrapped around structural elements like beams or posts to hold measuring devices or action cameras. This setup is particularly useful for monitoring work progress or conducting safety inspections, where recording or live-streaming the procedure can provide valuable documentation and compliance evidence.

Other exemplary uses include office or home environments, where the mount can be used to organize tools or gadgets. For example, it can securely hold tablets or smartphones on a desk or workshop table, adjusting to different angles suitable for video calls, watching tutorials, or following digital blueprints. In the kitchen, the system can be adapted for use in kitchens to hold recipe tablets or smartphones, attaching securely to appliances like refrigerators or metal cabinets. This allows for easy viewing of recipes or cooking videos without occupying counter space or risking damage to devices from spills. In creative settings, the system can be used to hold cameras or lights around different studio equipment, providing artists and musicians with the ability to record sessions hands-free. The flexibility of the mount allows it to be positioned around instruments, easels, or other artistic tools, capturing various angles of the creative process. For sports training environments, the system can be used to attach cameras to gym equipment, providing athletes and coaches with the ability to record and analyze training sessions. The secure attachment ensures that the camera remains stable during vigorous activities, such as on punching bags, weight racks, or even attached to basketball hoops for unique gameplay footage.

In another exemplary use related to field research, the system can be used to attach scientific instruments or cameras to natural elements like trees or underwater structures, facilitating environmental monitoring or wildlife studies. Its ability to securely wrap around irregular shapes and withstand environmental conditions makes it invaluable for capturing data in remote or challenging locations. For emergency responders in another exemplary use, the system can be used to attach critical tools or lighting to vehicles or equipment. Its quick deployment and secure hold can enhance operational efficiency during emergencies, allowing for hands-free lighting or recording in search and rescue operations.

These examples demonstrate the broad applicability of the mount across various industries and activities. Its unique combination of flexibility, secure magnetic attachment, and durability enables it to meet the needs of diverse applications, from professional and industrial to recreational and creative endeavors.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A mounting system comprising:
a main body comprising a plurality of flexible arms;
each of the flexible arms comprising:
at least one embedded magnet providing approximately 2.5 lbs of holding force;
wherein the flexible arms are constructed from a material selected from the group consisting of: commercial grade urethane, silicone rubber, thermoplastic elastomers, and reinforced polymers;
wherein the flexible arms are capable of bending through a 180-degree range of motion while maintaining structural integrity.

2. The mounting system of claim 1, wherein the plurality of flexible arms comprises two-ten flexible arms radiating from a central intersection point.

3. The mounting system of claim 1, further comprising:
an interchangeable puck retained at an intersection point of the flexible arms;
wherein the interchangeable puck comprises a polygonal shape having between 3 and 20 sides.

4. The mounting system of claim 3, wherein the interchangeable puck comprises:
a retention groove encircling its perimeter;
wherein the retention groove engages with a receptacle to prevent rotation and slippage.

5. The mounting system of claim 3, wherein the polygonal shape comprises:
a circumscribed circle diameter (D);
an inscribed circle diameter (d);
a side length(s) related to the diameter by s=D*sin(π/n) where n is the number of sides.

6. The mounting system of claim 3, wherein the interchangeable puck comprises facets that are:
flat, curved, or textured surfaces;
connected by edges that are sharp, rounded, or chamfered.

7. The mounting system of claim 3, wherein the interchangeable puck comprises:
a central aperture for cable routing or alignment features; or
a solid central surface for adhesive attachment or component embedding.

8. The mounting system of claim 3, wherein the interchangeable puck comprises:
variable facet angles for specific gripping requirements;
a hollow interior for weight reduction or component housing; or
articulated joints for additional positioning freedom.

9. A mounting system comprising:
a first body and a second body;
each body comprising an identical amount of flexible arms numbering two-twenty;
each flexible arm embedded with at least one magnet;
wherein the flexible arms of the first body align with the flexible arms of the second body when placed on opposite sides of an object to generate a clamping force.

10. The mounting system of claim 9, wherein:
the flexible arms are capable of conforming to irregular surfaces while maintaining magnetic alignment;
the magnets in opposing flexible arms create a compounded magnetic effect through an intervening material.

11. A mounting system comprising:
a main body comprising a plurality of flexible arms each emanating from a central location proximal to a receptacle for an interchangeable puck;
an interchangeable puck comprising a polygonal shape having between 3 and 20 sides;
wherein the polygonal shape is selected from the group consisting of: triangle, square, circle, hexagon, octagon, decagon, dodecagon, 16-sided polygon, and 20-sided polygon.

12. The mounting system of claim 11, wherein the polygonal shape comprises:
regular polygons having equal sides and angles; or
irregular polygons having varying sides and angles;
wherein the regular polygons provide predictable geometry and balanced force distribution.

13. The mounting system of claim 11, wherein the interchangeable puck comprises:
facets having flat, curved, or textured surfaces;
edges between facets that are sharp, rounded, or chamfered;
wherein the facets provide increased points of contact and friction to the receptacle compared to circular designs.

14. The mounting system of claim 11, wherein the interchangeable puck comprises:
a retention groove encircling its perimeter;
wherein the retention groove has a profile selected from the group consisting of: dovetail, square, and rounded;
wherein the retention groove engages with a complementary feature in the receptacle.

15. The mounting system of claim 11, wherein the interchangeable puck comprises:
a central portion configured to accept interchangeable inserts;
wherein the interchangeable inserts comprise different attachment mechanisms selected from the group consisting of: threaded inserts and action camera mounts.

16. The mounting system of claim 11, wherein the interchangeable puck comprises:
non-uniform facet angles for specific gripping requirements;
a hollow interior for weight reduction or component housing; or
hinges or joints providing additional degrees of freedom for device positioning.

17. The mounting system of claim 11, wherein the interchangeable puck comprises:
a locking mechanism selected from the group consisting of:
snap-fit mechanisms with flexible elements engaging a groove;
ball-detent mechanisms with spring-loaded balls engaging detents;
rotating cam mechanisms;
locking ring mechanisms; and
button release mechanisms.

18. The mounting system of claim 11, wherein the interchangeable puck comprises:
facet-specific locking features comprising inward-facing protrusions that align with corresponding recesses;
wherein rotation of the interchangeable puck engages the locking features.

19. The mounting system of claim 11, wherein the interchangeable puck comprises:
a central aperture configured to engage with a bayonet-style lock in the receptacle;
wherein rotating the interchangeable puck secures it within the receptacle.

20. The mounting system of claim 11, wherein:
the polygonal shape provides enhanced grip through faceted surfaces;
the faceted surfaces prevent loosening when locked with corresponding components;
the polygonal shape maintains compatibility with circular mounting system components.
